(19) United States
(12) Patent Application Publication
(10) Pub. No.: US 2014/0009722 A1
(43) Pub. Date: Jan. 9, 2014

(54) Liquid Crystal Display Device and Backlight Module Thereof

(71) Applicant: Chong Huang, Shenzhen (CN)

(72) Inventor: Chong Huang, Shenzhen (CN)

(73) Assignee: SHENZHEN CHINA STAR OPTOELECTRONICS TECHNOLOGY CO. LTD., Shenzhen (CN)

(21) Appl. No.: 13/578,255

(22) PCT Filed: Jul. 6, 2012
(86) PCT No.: PCT/CN12/78303

§ 371 Date: Aug. 10, 2012

(30) Foreign Application Priority Data
Jul. 4, 2012 (CN) 201210229700.9

(51) Int. Cl. F21V 7/04; G02F 1/13357

(52) U.S. Cl. 349/65; 362/612

(57) ABSTRACT

The present provides a backlight module comprises a waveguide. A reflective film is disposed under the waveguide. A backframe includes a backboard and sidewall arranged along peripheral of the backboard, the reflective film is arranged on a top surface of the backboard, and the waveguide is supported onto the reflective film with a side surface facing the sidewall of the backframe. A printed circuit board is disposed on the sidewall of the backframe located adjacent to the waveguide, and includes a first circuit board extending vertically, and a second circuit board extends horizontally from top or lower end of the first circuit board. A semi-conductor light source is disposed onto a portion of the first circuit board located adjacent to the waveguide; and wherein each of the first and second circuit boards has a reflective surface facing toward the semiconductor light source. The present invention further provides a liquid crystal display device. By the forgoing, the optical couplings between the semiconductor light source and the waveguide can be effectively increased.

### FIELD OF THE INVENTION

The present invention relates to a technical field of liquid crystal display, and more particularly to a liquid crystal display device, and a backlight incorporated therewith.

### DESCRIPTION OF PRIOR ART

In a backlight module with LED light source of side-entry type, the light beam projected from the LED light source will enter the waveguide from a side surface thereof, and then emit out of a light emitting surface of the waveguide after a total reflection within the waveguide. By this process, a light beam projected from the LED can be transformed into a surface light. Referring to FIG. 1 which is an illustrational and structural view of an existing and prior art backlight module. It can be readily seen that the backlight module 100 is a backlight module with a light source of side-entry, and it generally includes a waveguide 110, an LED light source 120, and a printed circuit board 130. The LED light source 120 is arranged on the printed circuit board 130 which is located closer to the light entry side of the waveguide 110. Since the light beam from the LED light source 120 is projected to all directions before it enters the waveguide 110. Apparently, some of the light does not enter the waveguide 110 because of refraction or reflection. In light of this, the coupling of the waveguide 110 with the LED light source does not achieve its maximum performance.

In order to resolve the prior art issues described above, the skill in the field provides a solution of increasing the size of a reflective film, i.e. the reflective film extends to a position under the LED light source so as to increase the optical coupling. However, with the factors of tolerance of the backframe, as well as the thermal expansion of the reflective film when heated up, the optical coupling between the LED light source and the waveguide is really unstable. As a result, increasing the size or dimension of the reflective film is not a best solution nowadays in this field.

### SUMMARY OF THE INVENTION

In order to resolve the technical issues described above, the present invention provides a liquid crystal display device and its backlight module in which the optical coupling performance between the LED light source and the waveguide is increased.

In order to resolve the prior art issue, the present provides a technical solution by introducing a backlight module that comprises a waveguide. A reflective film is disposed under the waveguide. A backframe includes a backboard and sidewall arranged along peripheral of the backboard. The reflective film is arranged on a top surface of the backboard, and the waveguide is supported onto the reflective film with a side surface facing the sidewall of the backframe. A printed circuit board is disposed on the sidewall of the backframe located adjacent to the waveguide, and includes a first circuit board extending vertically, and a second circuit board extends horizontally from top or lower end of the first circuit board. A semi-conductor light source is disposed onto a portion of the first circuit board located adjacent to the waveguide. Wherein each of the first and second circuit boards has a reflective surface facing toward the semiconductor light source. Wherein the second circuit board has a portion extends under the reflective film; and wherein the printed circuit board further includes a third circuit board which extends horizontally from the top of the first circuit board and toward the waveguide.

Wherein the second circuit board is located at lower end of the first circuit board, the backboard of the backframe is defined a recess with respect to the second circuit board for receiving the second circuit board therein.

Wherein the reflective surface of the first and second circuit boards are a polished surface or a surface with reflective material.

Wherein the third circuit board extends to a position above the waveguide, and a surface adjacent to the waveguide is a reflective surface.

In order to resolve the prior art issue, the present provides a technical solution by introducing a backlight module comprises a waveguide. A reflective film is disposed under the waveguide. A backframe includes a backboard and sidewall arranged along peripheral of the backboard, the reflective film is arranged on a top surface of the backboard, and the waveguide is supported onto the reflective film with a side surface facing the sidewall of the backframe. A printed circuit board is disposed on the sidewall of the backframe located adjacent to the waveguide, and includes a first circuit board extending vertically, and a second circuit board extends horizontally from top or lower end of the first circuit board. A semi-conductor light source is disposed onto a portion of the first circuit board located adjacent to the waveguide; and wherein each of the first and second circuit boards has a reflective surface facing toward the semiconductor light source.

Wherein the second circuit board is located at lower end of the first circuit board, the backboard of the backframe is defined a recess with respect to the second circuit board for receiving the second circuit board therein.

Wherein the second circuit board has a portion extends under the reflective film.

Wherein the reflective surface of the first and second circuit boards are a polished surface or a surface with reflective material.

Wherein the printed circuit board further includes a third circuit board which extends horizontally from the top of the first circuit board and toward the waveguide.

Wherein the third circuit board extends to a position above the waveguide, and a surface adjacent to the waveguide is a reflective surface.

In order to resolve the prior art issue, the present provides a technical solution by introducing a liquid crystal display device, comprises a liquid crystal display panel and a backlight module which includes a waveguide. A reflective film is disposed under the waveguide. A backframe includes a backboard and sidewall arranged along peripheral of the backboard and the reflective film is arranged on a top surface of the backboard, and the waveguide is supported onto the reflective film with a side surface facing the sidewall of the backframe. A printed circuit board is disposed on the sidewall of the backframe located adjacent to the waveguide, and includes a first circuit board extending vertically, and a second circuit board extending horizontally from top or lower end of the first circuit board. A semi-conductor light source is disposed onto a portion of the first circuit board located adjacent to the waveguide; and wherein each of the first and second circuit boards has a reflective surface facing toward the semiconductor light source.

Wherein the second circuit board is located at lower end of the first circuit board, the backboard of the backframe is defined a recess with respect to the second circuit board for receiving the second circuit board therein.

Wherein the printed circuit board further includes a third circuit board which extends horizontally from the top of the first circuit board and toward the waveguide.

Wherein the third circuit board extends to a position above the waveguide, and a surface adjacent to the waveguide is a reflective surface.

The present invention cart be concluded with the following advantages: as compared with the existing prior arts, the present invention introduces an innovation to modify the printed circuit board of the semiconductor light source into a first circuit board along the vertical direction, and a second circuit board extending from top or tower end of the first circuit board. With a genuine enclosure and reflection of the printed circuit board, the projected light beam from the semiconductor light source, which was once diverted from entering of the waveguide, can be readily directed into the waveguide by the reflection surface of the first and second circuit boards. By this arrangement, the optical couplings between the semiconductor light source and the waveguide can be effectively increased.

### BRIEF DESCRIPTION OF DRAWINGS

FIG. 1 is a structural view of a prior art backlight module;

FIG. 2 is an illustrational and structural of a backlight module made in accordance with a first embodiment of the present invention; and

FIG. 3 is an illustrational and structural of a backlight module made in accordance with a second embodiment of the present invention.

### DETAILED DESCRIPTION OF PREFERRED EMBODIMENT

In order clearly explain the technology of the embodiment illustrated in the present invention, a brief and concise description will be given along with the accompanied drawings. Apparently, the embodiments illustrated in the drawings are merely some typical embodiments and which can be readily modified by the skilled in the art without any additional laborious efforts so as to transform them into other drawings, and they should all be covered by the appended claims.

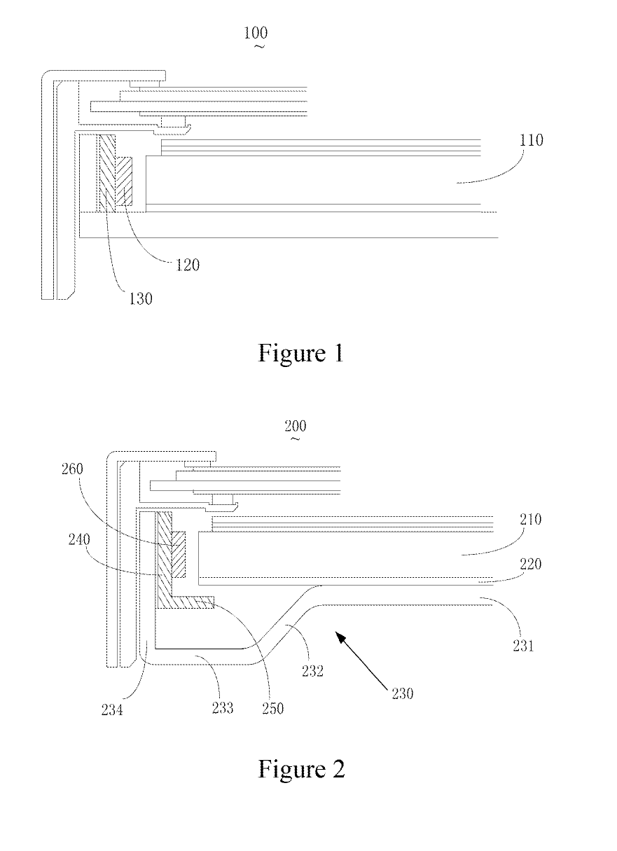

Referring to FIG. 2, which is an illustrational and structural of a backlight module made in accordance with a first embodiment of the present invention.

The backlight module 200 made in accordance with the first embodiment of the present invention generally includes a waveguide 210, a reflective film 220, a backframe 230, a printed circuit board (240, 250), and a semiconductor light source 260.

The backframe 230 includes a backboard (231, 232, and 233), and a sidewall 234. The reflective film 220 is disposed under the waveguide 210, and portion of the reflective film 220 is disposed on a surface of a supporting portion 231 of the backboard (231, 232, and 234). The other portion of the reflective film 220 is exposed on the supporting portion 231 in an area adjacent to an outer skirt adjacent to the sidewall 234. The waveguide 210 is further disposed on the reflective film 220, and lacing to the sidewall 234.

The printed circuit board (240, 250) includes a first circuit board 240 extending vertically, and a second circuit board 250 extending horizontally from a lower portion of the first circuit board 240 toward the waveguide 210. The printed circuit board (240, 250) is disposed on the sidewall 234 adjacent to the waveguide 210. Substantially, the first circuit board 240 is disposed on a side adjacent to the waveguide 210. It should be noted that the second circuit board 250 can extend horizontally from atop or lower end of the first circuit board 240 toward the waveguide 210. In the current embodiment, the printed circuit board is a metal-core-printed-circuit-board (MCPCB). In other embodiment, the printed circuit board can be replaced with other suitable printed circuit board while is not merely limited to MCPCB.

The second circuit board 250 is disposed on the lower portion of the first circuit board 240. As it can be clearly seen from FIG. 2, the backboard (231, 232, and 233) of the backframe 230 has a recess 233 with respect to the second circuit board 250 so as to receive the second circuit board 250 therein. The supporting portion 231 of the backboard (231, 232, and 233) interconnects with the recess 233 with a curve portion 232.

The semiconductor light source 260 is disposed on the side of the first circuit board 240 closer to the waveguide 210. Both the first and second circuit boards 240, 250 have reflective surface facing toward the semiconductor light source 260. The semiconductor light source 260 could be an LED light source or any other suitable semiconductor light source. It should be noted that the second circuit board 250 extends under the reflective film 220. For the light beam emitted from the semiconductor light source 260 and eventually failed to enter the waveguide 210 because of reflection or refraction can now be properly redirected by the reflective surfaces of the first and second circuit boards 240, 250 and enter the waveguide 210. The reflective surfaces of the first and second circuit boards 240, 250 can be created by polishing or by evaporation deposition of highly reflective material over those surfaces. However, the present invention should not be limited to those measurements.

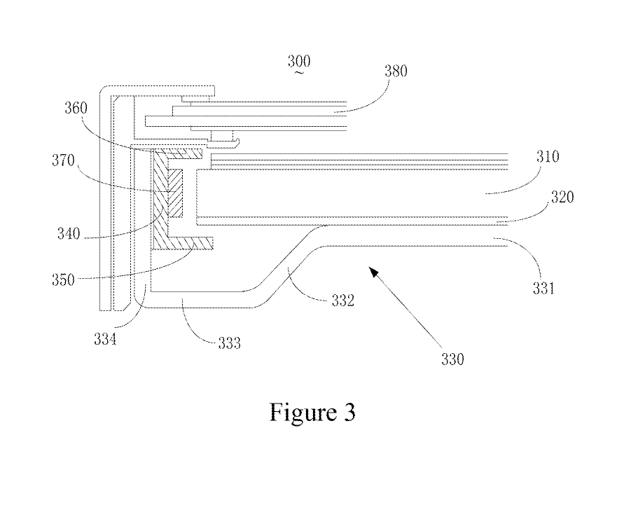

Referring to FIG. 3, which is an illustrational and structural of a backlight module made in accordance with a second embodiment of the present invention.

The backlight module 300 made in accordance with the second embodiment of the present invention generally includes a waveguide 310, a reflective film 320, a backframe 330, a printed circuit board (340, 350, and 360), and a semiconductor light source 370.

The backframe 330 includes a backboard (331, 332, and 333), and a sidewall 334. The reflective film 320 is disposed under the waveguide 310, and portion of the reflective film 320 is disposed on a surface of a supporting portion 331 of the backboard (331, 332, and 334). The other portion of the reflective film 320 is exposed on the supporting portion 331 in an area adjacent to an outer skirt adjacent to the sidewall 334. The waveguide 310 is further disposed on the reflective film 320, and facing to the sidewall 334.

The printed circuit board (340, 350, and 360) is disposed on a side of the sidewall 334 closer to the waveguide 310, and includes a first circuit board 340 extending vertically, and a second circuit board 350 extending horizontally from a lower portion of the first circuit board 340, and a third circuit board 360 extending horizontally from atop of the first circuit board 240 toward the waveguide 310.

The second circuit board 350 is disposed on a lower portion of the first circuit board 340. As seen from the FIG. 3, the backboard (331, 332, and 333) of the backframe 330 is defined with a recess 333 corresponding to the second circuit board 350 such that the second circuit board 350 can be received therein. The supporting portion 331 and the recess 333 are interconnected by a curve portion 332.

The third circuit board 360 is disposed on atop of the first circuit board 340, and partially reaches above of the waveguide 310. A surface closer to the waveguide 310 is a reflective surface. The semiconductor light source 370 is arranged on the first circuit board 340 closer to the waveguide 310. Both the first and second circuit boards 340, 350 are provided with reflective surfaces facing to the semiconductor light source 370. The second circuit board 350 reaches to a lower portion of the reflective film 320. For the light beam emitted from the semiconductor light source 370 and eventually failed to enter the waveguide 310 because of reflection or refraction can now be properly redirected by the reflective surfaces of the first and second circuit boards 340, 350, 360 and enter the waveguide 310. The reflective surfaces of the first and second circuit boards 340, 350 and 360 can be created by polishing or by evaporation deposition of highly reflective material over those surfaces. However, the present invention should not be limited, to those measurements.

Referring now to FIG. 3 again, and the present invention also provides a liquid crystal display device which further includes a panel 380, and a backlight module 300 providing luminous light source to the panel 380. The backlight module 300 made in accordance with the second embodiment of the present invention generally includes a waveguide 310, a reflective film 320, a backframe 330, a printed circuit board (340, 350, and 360), and a semiconductor light source 370. The reflective film 320 is disposed under the waveguide 310. The backframe 330 includes a backboard (331, 332, and 333), and a sidewall 334 arranged aside. The reflective film 320 is disposed on a top surface of the backboard (331, 332, and 333) and has a side facing the sidewall 334 of the backframe 330. The printed circuit board (340, 350 and 360) is disposed on a side of the sidewall 334 of the backframe 330 closer to the waveguide 310, and includes a first circuit board 340, and a second circuit board 350 extending horizontally from atop or lower end of the first circuit board 340 toward the waveguide 310. The semiconductor light source 370 is arranged on the side of the first circuit board 340 closer to the waveguide 310. Both of the first and second circuit boards 340, 350 are provided with reflective surfaces facing toward the semiconductor light source 370.

The second circuit board 350 is arranged on the lower portion of the first circuit board 340, and the backboard (331, 332, 333) of the backframe 330 is defined with a recess to receive the second circuit board 350. The printed circuit board (340, 350, 360) further includes a third circuit board 360, which extends horizontally from atop of the first circuit board 340 to reaches above the waveguide 310. The third circuit board 360 extends above the waveguide 310, and includes a reflective surface closer to the waveguide 310. The panel can be a TFT-LCD module, or other existing liquid crystal display device, and should not be limited to what disclosed herein in the embodiment.

As compared with the existing prior arts, the present invention introduces an innovation to modify the printed circuit board (340, 350, 360) of the semiconductor light source 370 into a first circuit board 340 along the vertical direction, and a second circuit board 350 extending from a lower portion of the first circuit board 340, and a third circuit board 360 extending horizontally from atop of the first circuit board 340. The third circuit board 360 reaches above the waveguide 310. With a genuine enclosure and reflection of the printed circuit board (340, 350, 360), the projected light beam from the semiconductor light source 370, which were once diverted from entering of the waveguide 310, can be readily directed into the waveguide 310 by the reflection surface of the first, second and third circuit boards 340, 350, 360. By this arrangement, the optical couplings between the semiconductor light source and the waveguide can be effectively increased.

It should be noted that in other embodiments of the present invention, the second and third circuit boards 350, 360 of the printed circuit board (340, 350, 360) can be designed with a circular transition so as to make a smooth interconnection with the first circuit board 340 of the printed circuit board (340, 350, 360) from top and lower end thereof. Accordingly, the printed circuit board (340, 350, 360) can be readily utilized to increase the optical coupling between the semiconductor light source 370 and the waveguide 310 with reflection and refraction provided by the of the printed circuit board (340, 350, 360)

Embodiments of the present invention have been described, but not intending to impose any unduly constraint to the appended claims. Any modification of equivalent structure or equivalent process made according to the disclosure and drawings of the present invention, or any application thereof, directly or indirectly, to other related fields of technique, is considered encompassed in the scope of protection defined by the clams of the present invention.

1. A backlight module, comprising;
a waveguide;
a reflective film, disposed under the waveguide;
a backframe including a backboard and sidewall arranged along peripheral of the backboard, the reflective film being arranged on a top surface of the backboard, and the waveguide being supported onto the reflective film with a side surface facing the sidewall of the backframe;
a printed circuit board, disposed on the sidewall of the backframe located adjacent to the waveguide, and including a first circuit board extending vertically, and a second circuit board extending horizontally from top or lower end of the first circuit board;
a semi-conductor light source disposed onto a portion of the first circuit board located adjacent to the waveguide;
wherein each of the first and second circuit boards has a reflective surface facing toward the semiconductor light source;
wherein the second circuit board has a portion extends under the reflective film; and
wherein the printed circuit board further includes a third circuit board which extends horizontally from the top of the first circuit board and toward the waveguide.

2. The backlight module as recited in claim 1, wherein the second circuit board is located at lower end of the first circuit board, the backboard of the backframe is defined a recess with respect to the second circuit board for receiving the second circuit board therein.

3. The backlight module as recited in claim 1, wherein the reflective surface of the first and second circuit boards are a polished surface or a surface with reflective material.

4. The backlight module as recited in claim 1, wherein the third circuit board extends to a position above the waveguide, and a surface adjacent to the waveguide is a reflective surface.

5. A backlight module, comprising:
a waveguide;
a reflective film disposed under the waveguide;
a backframe including a backboard and sidewall arranged along peripheral of the backboard, the reflective film being arranged on a top surface of the backboard, and the waveguide being supported onto the reflective film with a side surface feeing the sidewall of the backframe;
a printed circuit board disposed on the sidewall of the backframe located adjacent to the waveguide, and including a first circuit board extending vertically, and a second circuit board extending horizontally from top or lower end of the first circuit board;
a semi-conductor light source disposed onto a portion of the first circuit board located adjacent to the waveguide; and
wherein each of the first and second circuit boards has a reflective surface facing toward the semiconductor light source.

6. The backlight module as recited in claim 5, wherein the second circuit board is located at lower end of the first circuit board, the backboard of the backframe is defined a recess with respect to the second circuit board for receiving the second circuit board therein.

7. The backlight module as recited in claim 6, wherein the second circuit board has a portion extends under the reflective film.

8. The backlight module as recited in claim 7, wherein the reflective surface of the first and second circuit boards are a polished surface or a surface with reflective material.

9. The backlight module as recited in claim 6, wherein the printed circuit board further includes a third circuit board which extends horizontally from the top of the first circuit board and toward the waveguide.

10. The backlight module as recited in claim 9, wherein the third circuit board extends to a position above the waveguide, and a surface adjacent to the waveguide is a reflective surface.

11. A liquid crystal display device, comprising:
a liquid crystal display panel;
a backlight module, including
a waveguide;
a reflective film, disposed under the waveguide;
a backframe including a backboard and sidewall arranged along peripheral of the backboard, the reflective film being arranged on a top surface of the backboard, and the waveguide being supported onto the reflective film with a side surface facing the sidewall of the backframe;
a printed circuit board disposed on the sidewall of the backframe located adjacent to the waveguide, and including a first circuit board extending vertically, and a second circuit board extending horizontally from top or lower end of the first circuit board;
a semi-conductor light source disposed onto a portion of the first circuit board located adjacent to the waveguide; and
wherein each of the first and second circuit boards has a reflective surface facing toward the semiconductor light source.

12. The liquid crystal display device as recited in claim 11, wherein the second circuit board is located at lower end of the first circuit board, the backboard of the backframe is defined a recess with respect to the second circuit board for receiving the second circuit board therein.

13. The liquid crystal display device as recited in claim 12, wherein the printed circuit board further includes a third circuit board which extends horizontally from the top of the first circuit board and toward the waveguide.

14. The liquid crystal display device as recited in claim 13, wherein the third circuit board extends to a position above the waveguide, and a surface adjacent to the waveguide is a reflective surface.
